(19) United States
(12) Patent Application Publication
(10) Pub. No.: US 2005/0005284 A1
(43) Pub. Date: Jan. 6, 2005

(54) Optical storage medium and method of manufacturing same

(76) Inventors: Petrus Helena Gerardus Maria Vromans, Eindhoven (NL); Igolt Pieter Douwes Ubbens, Eindhoven (NL); Michel Marcel Jose Decre, Eindhoven (NL)

Correspondence Address: Corporate Patent Counsel;Philips Electronics North America Corporation, PO Box 3001, Briarcliff Manor, NY, 10510, US

(21) Appl. No.: 10/487,732

(22) PCT Filed: Aug. 26, 2002
(86) PCT No.: PCT/IB02/03527

(30) Foreign Application Priority Data
Aug. 29, 2001 (EP) 01203258.7

(51) Int. Cl. G11B 7/24

(52) U.S. Cl. 720/718

(57) ABSTRACT

The invention describes an optical data storage medium comprising a substrate (2), a spacer layer (5) and a cover layer (8). The medium comprises two information layers (3, 4) and (6, 7). The invention further describes methods of manufacturing such an information medium (1), which relate to the manner in which the information layers are provided with data patterns. The invention further discloses a method wherein an UV light (10)-transparent stamper (9) is used in combination with a photopolymerization lacquer and/or pressure-sensitive adhesives.

The invention relates to an optical storage medium which successively comprises

i) a substrate,

ii) a first data pattern of pits/grooves

iii) a first stack of layers adjoining the first data pattern

iv) a spacer

v) a second stack of layers

vi) a second data pattern of pits/grooves, and

vii) a cover.

Such an optical storage medium is known from, for example, U.S. Pat. No. 5,679,429. A polycarbonate substrate obtained by injection molding and comprising a data pattern was provided with a reflection layer of amorphous silicon carbide by means of sputtering. The disc thus composed was placed in a spin coater, after which a spacer layer of an UV-curable photopolymer was provided while rotating said disc. After curing of this spacer layer, a second photopolymer layer was provided thereon and cured. Subsequently, a third photopolymer layer was provided, after which a stamper, which comprises a negative of the second data pattern, was brought into contact with the non-cured, third photopolymer that was subsequently cured by exposure to UV radiation, after which the stamper was carefully removed. A reflection layer was applied to the second data pattern thus provided, which reflection layer was finally provided with a cover.

One of the trends in optical storage media is to increase the storage capacity. This object can be achieved by reducing the laser wavelength λ and/or by increasing the numerical aperture (NA) as the dimension of the laser spot is proportional to (λ/NA)². Alternatively, this can be achieved by using multiple recording layers.

An object of the invention is, inter alia, to provide an optical storage medium that can be considered to be composed of elements that are interconnected, which elements are individually manufactured.

In accordance with the invention, this object is achieved in that the above-mentioned elements of the storage medium successively are:

a) a substrate provided with the first data pattern of pits/grooves over which the first stack of layers is provided,

b) a spacer,

c) a cover provided with the second data pattern of pits/grooves over which the second stack of layers is provided, said second stack of layers lying against the spacer b).

In a particular embodiment of the invention, the storage medium can be considered to be composed of elements that are interconnected, said elements successively being:

a) a substrate provided with the first data pattern of pits/grooves, over which the first stack of layers is provided,

d) a spacer provided with the second stack of layers over which the second data pattern of pits/grooves is provided, said second data pattern being separated from the first data pattern by the spacer,

e) a cover.

In accordance with a different, preferred embodiment, the storage medium in question can be considered to be composed of elements that are interconnected, said elements successively being:

f) a substrate,

g) a spacer provided with the first stack of layers over which the first data pattern of the pits/grooves is provided, said first data pattern lying against the substrate,

c) a cover provided with the second data pattern of pits/grooves over which the second stack of layers is provided, said second stack lying against the spacer g).

In accordance with yet another embodiment of the invention, the optical storage medium can be considered to be composed of elements that are interconnected, said elements successively being:

f) a substrate,

h) a spacer that is provided, on one side, with the first stack of layers over which the first data pattern of pits/grooves is provided, and, on the other side, with the second stack of layers over which the second data pattern of pits/grooves is provided, and

e) a cover.

The transparent substrate employed in the optical storage medium in question can be composed of any polymeric material enabling pits/grooves to be formed therein with a view to forming a data pattern, such as polycarbonate or an amorphous polyolefin compound. Alternatively, use can be made of a flat substrate of, for example, glass or polymethylmethacrylate, in which case the data pattern of pits and/or grooves is formed by means of photopolymer replication.

The spacer used in the optical storage medium in question may be a polymer, such as a radiation-curable polymer. The transparent spacer layer must be thick enough to enable a laser source to focus on the first data pattern as well as on the second data pattern, whereby interference must be reduced to a minimum. The reflection layer used in the optical storage medium in question is, in particular, a metal layer having a high reflection at the laser wavelength used to reproduce the data patterns. Examples of suitable metals are aluminum, gold, silver, copper and alloys thereof.

The invention further relates to a method of manufacturing an optical storage medium, which method is characterized in that the element c) in question is obtained by means of the following steps:

c1) providing the cover material with an auxiliary substrate,

c2) applying a photopolymerizable lacquer to the cover material,

c3) placing a stamper on the photopolymerizable lacquer,

c4) carrying out a polymerization reaction and removing the stamper,

c5) sputtering a stack of layers onto the structured photopolymerizable lacquer, and

c6) removing the auxiliary substrate.

In a particular embodiment it is particularly preferred that the above-mentioned element d) is obtained by means of the following steps:

d1) applying a photopolymerizable lacquer to a stamper,

d2) carrying out a polymerization treatment, and

d3) connecting the lacquer polymerized in step d2) to a spacer,

d4) removing the stamper,

d5) sputtering a stack of layers onto the structured photopolymerizable lacquer.

In another embodiment, the method in question is characterized in that the above-mentioned element d) or g) is obtained by means of the following steps:

d6) applying a stack of layers to a stamper,

d7) applying a photopolymerizable lacquer to the stack of layers, and

d8) carrying out a polymerization reaction so as to form a structured photopolymerizable lacquer that is provided with a stack of layers.

In yet another embodiment, the method in question is characterized in that the above-mentioned element d) is obtained by means of the following steps:

d9) providing the spacer on the element a),

d10) placing an UV radiation-transparent stamper on the spacer of step d9),

d11) carrying out a polymerization reaction,

d12) removing the stamper, and finally

d13) sputtering a stack of layers onto the structured photopolymerizable lacquer as obtained after step d11).

In a refinement of the last-mentioned embodiment, steps d9)-d10) are divided into four sub-steps, i.e.:

d14) providing the spacer on the element a)

d15) carrying out a polymerization reaction,

d16) providing an additional spacer on the polymerized spacer of d15), and

d17) placing an UV radiation-transparent stamper on said additional spacer of

d16).

The transparent stamper may be, for example, a transparent synthetic resin substrate that can be manufactured using a known nickel stamper in an injection molding process. The transparent substrate may comprise the same materials as those mentioned above in the description of the optical storage medium.

In addition, one or more of the above elements a)-g) may be interconnected by means of a pressure-sensitive adhesive (PSA) or a photopolymerization lacquer (2p).

These and other aspects of the invention are apparent from and will be elucidated with reference to the embodiments described hereinafter.

In the drawings:

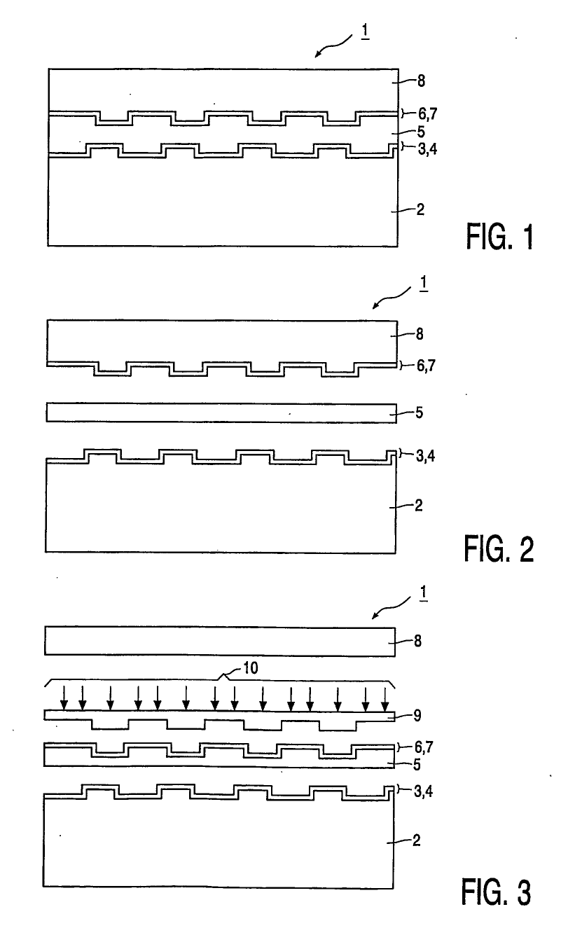

FIG. 1 shows a finished optical storage medium in accordance with the invention,

FIG. 2 shows a particular embodiment of the optical storage medium in accordance with the invention,

FIG. 3 shows a different embodiment of the optical storage medium in accordance with the invention,

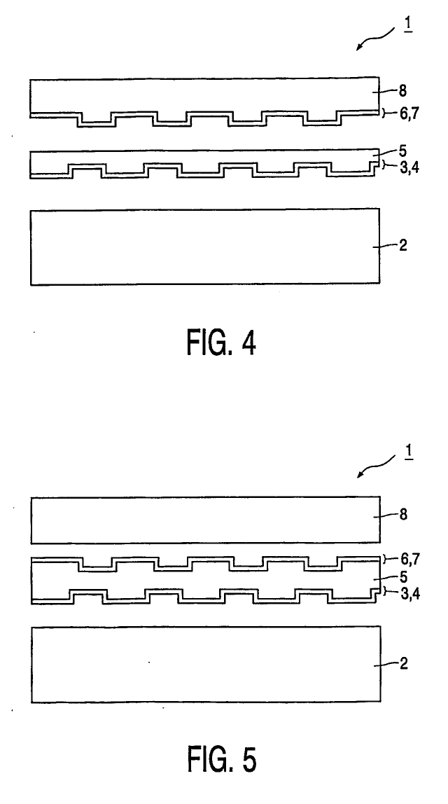

FIG. 4 shows yet another embodiment of the optical storage medium in accordance with the invention, and

FIG. 5 shows a further embodiment of the optical storage medium in accordance with the invention.

In FIG. 1, an optical storage medium 1 comprises, in succession, a substrate 2, a first data pattern of pits/grooves 3, a first stack 4 of layers adjoining the first data pattern 3, a spacer 5, a second stack 6 of layers, a second data pattern of pits/grooves 7 and, finally, a cover 8.

A particular embodiment of the optical storage medium 1 in accordance with the invention is diagrammatically shown in FIG. 2, which Figure can be considered to be a combination of three separate parts, i.e. a substrate 2 provided with the first data pattern of pits/grooves 3 over which the first stack 4 of layers is provided, a spacer 5 and, finally, a cover 8 that is provided with the second data pattern of pits/grooves 7 over which the second stack 6 of layers is provided.

FIG. 3 shows a particular embodiment of the optical storage medium 1 in accordance with the invention, which optical storage medium 1 can be considered to be composed of three individual parts, i.e. a substrate 2 provided with the first data pattern of pits/grooves 3 over which the first stack 4 of layers is provided, a spacer 5 that is provided with the second stack 6 of layers and the second data pattern of pits/grooves 7, and a cover 8. The data pattern of pits/grooves 7 is provided by means of an UV radiation-transparent stamper 9 by carrying out a polymerization reaction caused by UV radiation 10 that is projected through the transparent stamper 9.

FIG. 4 shows a particular embodiment of the optical storage medium 1 in accordance with the invention, which optical storage medium 1 is to be considered to be a combination of three individual parts, i.e. a substrate 2, a spacer 5 provided with the first stack 4 of the layers and the first data pattern of pits/grooves 3, and a cover 8 that is provided with the second data pattern of pits/grooves 7 and the second stack 6 of layers.

FIG. 5 diagrammatically shows yet another embodiment of the optical storage medium 1 in accordance with the invention, which optical storage medium 1 can be considered to be a combination of individual parts, i.e. a substrate 2, a spacer 5 that is provided, on one side, with the first data pattern 3 of pits/grooves over which the first stack 4 of layers is provided, and, on the other side, with the second data pattern 7 of pits/grooves over which the second stack 6 of layers is provided.

1. An optical storage medium (1) which successively comprises
i) a substrate (2),
ii) a first data pattern (3) of pits/grooves
iii) a first stack (4) of layers adjoining the first data pattern (3)
iv) a spacer (5)
v) a second stack (6) of layers
vi) a second data pattern (7) of pits/grooves, and
vii) a cover (8), characterized in that the storage medium (1) can be considered to be composed of elements that are interconnected, said elements successively being:
a) a substrate (2) provided with the first data pattern (3) of pits/grooves over which the first stack (4) of layers is provided,
b) a spacer (5),
c) a cover (8) provided with the second data pattern (7) of pits/grooves over which the second stack (6) of layers is provided, said second stack (6) of layers lying against the spacer (b), (5).

2. An optical storage medium (1) that successively comprises
i) a substrate (2),
ii) a first data pattern (3) of pits/grooves,
iii) a first stack (4) of layers adjoining the first data pattern (3)
iv) a spacer (5)
v) a second stack (6) of layers,
vi) a second data pattern (7) of pits/grooves,
vii) a cover (8), characterized in that the storage medium can be considered to be composed of elements that are interconnected, which elements successively are:
a) a substrate (2) provided with the first data pattern (3) of pits/grooves over which the first stack (4) of layers is provided
d) a spacer (5) provided with the second stack (6) of layers over which the second data pattern (7) of pits/grooves is provided, said second data pattern (7) being separated from the first data pattern (3) by the spacer (5),
e) a cover (8).

3. An optical storage medium (1) that successively comprises
i) a substrate (2),
ii) a first data pattern (3) of pits/grooves
iii) a first stack (4) of layers adjoining the first data pattern (3)
iv) a spacer (5)
v) a second stack (6) of layers,
vi) a second data pattern (7) of pits/grooves, and
vii) a cover (5), characterized in that the storage medium (1) can be considered to be composed of elements that are interconnected, which elements successively are:
f) a substrate (2),
g) a spacer (5) provided with the first stack (4) of layers over which the first data pattern (3) of pits/grooves is provided, said first data pattern lying against the substrate (2),
c) a cover (5) provided with the second data pattern (7) of pits/grooves over which the second stack (6) of layers is provided, said second stack (6) of layers lying against the spacer (g), 5).

4. An optical storage medium (1), which successively comprises
i) a substrate (2)
ii) a first data pattern (3) of pits/grooves,
iii) a first stack (4) of layers adjoining the first data pattern (3),
iv) a spacer (5)
v) a second stack (6) of layers,
vi) a second data pattern (7) of pits/grooves, and
vii) a cover (5), characterized in that the storage medium (1) can be considered to be composed of elements that are interconnected, which elements successively are:
f) a substrate (2),
h) a spacer (5) which is provided, on one side, with the first data pattern (3) of pits/grooves over which the first stack (4) of layers is provided, and, on the other side, with the second data pattern (7) of pits/grooves over which the second stack (6) of layers is provided, and
e) a cover (8).

5. A method of manufacturing an optical storage medium (1) as claimed in claims 1, 3, characterized in that the element c) is obtained by means of the following steps:
c1) providing the cover material with an auxiliary substrate,
c2) applying a photopolymerizable lacquer to the cover material,
c30 placing a stamper on the photopolymerizable lacquer,
c40 carrying out a polymerization reaction and removing the stamper,
c5) sputtering a stack of layers onto the structured photopolymerizable lacquer, and
c6) removing the auxiliary substrate.

6. A method of manufacturing an optical storage medium (1) as claimed in claim 2, characterized in that element d) is obtained by means of the following steps:
d1) applying a photopolymerizable lacquer to a stamper,
d2) carrying out a polymerization treatment, and
d3) connecting the lacquer polymerized in step d2) to a spacer (5),
d4) removing the stamper,
d5) sputtering a stack of layers onto the structured photopolymerizable lacquer.

7. A method of manufacturing an optical storage medium (1) as claimed in claim 2, characterized in that element d) or g) is obtained by means of the following steps:
d6) applying a stack (6) of layers to a stamper,
d7) applying a photopolymerizable lacquer to the stack (6) of layers, and
d8) carrying out a polymerization reaction so as to form a structured photopolymerizable lacquer that is provided with a stack of layers (6).

8. A method of manufacturing an optical storage medium (1) as claimed in claim 2, characterized in that element d) is obtained by means of the following steps:
d9) providing the spacer (5) on the element a),
d10) placing an UV radiation (10)-transparent stamper (9) on the spacer (5) of step d9),
d11) carrying out a polymerization reaction,
d12) removing the transparent stamper (9), and finally
d13) sputtering a stack (6) of layers onto the structured photopolymerizable lacquer as obtained after step d11).

9. A method of manufacturing an optical storage medium (1) as claimed in claim 8, characterized in that steps d9)-d10) are divided into four sub-steps, i.e.:
d14) providing the spacer (5) on element a)
d15) carrying out a polymerization reaction,
d16) providing an additional spacer on the polymerized spacer of d15), and
d17) placing the UV radiation (10)-transparent stamper (9) on said additional spacer of d16).

10. A method of manufacturing an optical storage medium (1) as claimed in claim 1, characterized in that one or more of the elements a)-g) are interconnected by means of a pressure-sensitive adhesive or a photopolymerization lacquer.
